(19) United States
(12) Patent Application Publication
(10) Pub. No.: US 2011/0254806 A1
(43) Pub. Date: Oct. 20, 2011

(54) METHOD AND APPARATUS FOR INTERFACE

(75) Inventors: Jong-woo JUNG, Hwaseong-si (KR); In-sik Myung, Bupyeong-gu (KR); Joo-kyung Woo, Suji-gu (KR); Young-shil Jang, Suwon-si (KR)

(73) Assignee: Samsung Electronics Co., Ltd., Suwon-si (KR)

(21) Appl. No.: 13/089,926

(22) Filed: Apr. 19, 2011

(30) Foreign Application Priority Data
Apr. 19, 2010 (KR) 10-2010-0035891

(51) Int. Cl. G06F 3/045

(52) U.S. Cl. 345/174

(57) ABSTRACT

A method and apparatus for interfacing, the method including detecting waveforms generated due to contact between a plurality of input members and an input surface for receiving touch inputs; obtaining property information regarding each input member based on the detected waveforms; and generating an input signal corresponding to a combination of the property information of the input members and gestures generated by the input members.

### PRIORITY

This application claims priority under 35 U.S.C. §119(a) to Korean Patent Application No. 10-2010-0035891, filed on Apr. 19, 2010, in the Korean Intellectual Property Office, the entire disclosure of which is incorporated herein by reference.

### BACKGROUND OF THE INVENTION

1. Field of the Invention

The present invention relates generally to a method and apparatus for interfacing, and more particularly, to a method and apparatus for providing an interface by analyzing waveforms generated during touching.

2. Description of the Related Art

Today, various types of apparatuses including a displaying means with a touch sensor have been developed. Various methods of providing an intuitive and easy interface for users using a touch sensor have been considered. Users may perform desired operations by touching a display of a small device.

### SUMMARY OF THE INVENTION

The present invention provides an interface having various functions according to obtained property information of a plurality of input members.

According to one aspect of the present invention, an interface method is provided, including detecting waveforms generated due to contact between a plurality of input members and an input surface for receiving touch inputs; obtaining property information regarding each input member based on the detected waveforms; and generating an input signal corresponding to a combination of the property information of the input members and gestures generated by the input members.

### BRIEF DESCRIPTION OF THE DRAWINGS

The above and other features and advantages of the present invention will become more apparent by describing in detail embodiments thereof with reference to the attached drawings in which:

FIG. 1 is a block diagram illustrating an interface device, according to an embodiment of the present invention;

FIG. 2 is a diagram illustrating a reference waveform and a detected waveform generated when the interface device of FIG. 1 is touched (by a hand or a stylus);

FIG. 3 is a flowchart illustrating an interfacing method, according to an embodiment of the present invention;

FIGS. 4 through 12 are diagrams illustrating a method of performing a touch input using the interface device of FIG. 1; and

FIG. 13 is a flowchart illustrating an interfacing method, according to another embodiment of the present invention.

### DETAILED DESCRIPTION OF EMBODIMENTS OF THE PRESENT INVENTION

An embodiment, according to the present invention, will be now be described in detail referring to the accompanying drawings.

FIG. 1 is a block diagram of an interface device 100, according to an embodiment of the present invention. The interface device 100 includes an input surface 110, a waveform detecting unit 120, a property information obtaining unit 130, and an input signal generating unit 140. The input surface 110 is a surface that receives a touch input of an input member such as a finger or a stylus. The input surface 110 may include a capacitive overlay touchpad for sensing a touch of an input member through a change in capacitance or a resistive touchpad for sensing a touch of an input member through a change in pressure.

The waveform detecting unit 120 detects a waveform generated by a touch input. If an input member touches the input surface 110, a unique vibration or sound is generated depending on a characteristic of the input member. The waveform detecting unit 120 detects a waveform by processing a vibration or sound generated when an input member touches the input surface 110 in a frequency domain. When a plurality of input members touch the input surface 110 at the same time, the waveform detecting unit 120 may detect a plurality of waveforms corresponding to each input member from one waveform.

The property information obtaining unit 130 obtains property information regarding an input member based on the detected waveform. Such property information may include various pieces of information regarding an input member. For example, such property information may include information such as a type or shape of an input member.

The property information obtaining unit 130 may obtain information regarding a type and shape of an input member by comparing a detected waveform with another waveform or comparing detected waveforms with each other, or by using information other than waveforms.

First, a case where the property information obtaining unit 130 compares a detected waveform with a reference waveform or compares detected waveforms with each other in order to obtain property information regarding an input member will be described.

The property information obtaining unit 130 may obtain property information regarding an input member that is touching the input surface 110 by comparing one or more reference waveforms stored in a database with a detected waveform. The database may store a reference waveform for each of a plurality of input members and store a reference waveform for each of states of the input members. For example, a reference waveform when a thumb touches the input surface 110 and a reference waveform when an index finger touches the input surface 110 may be individually stored.

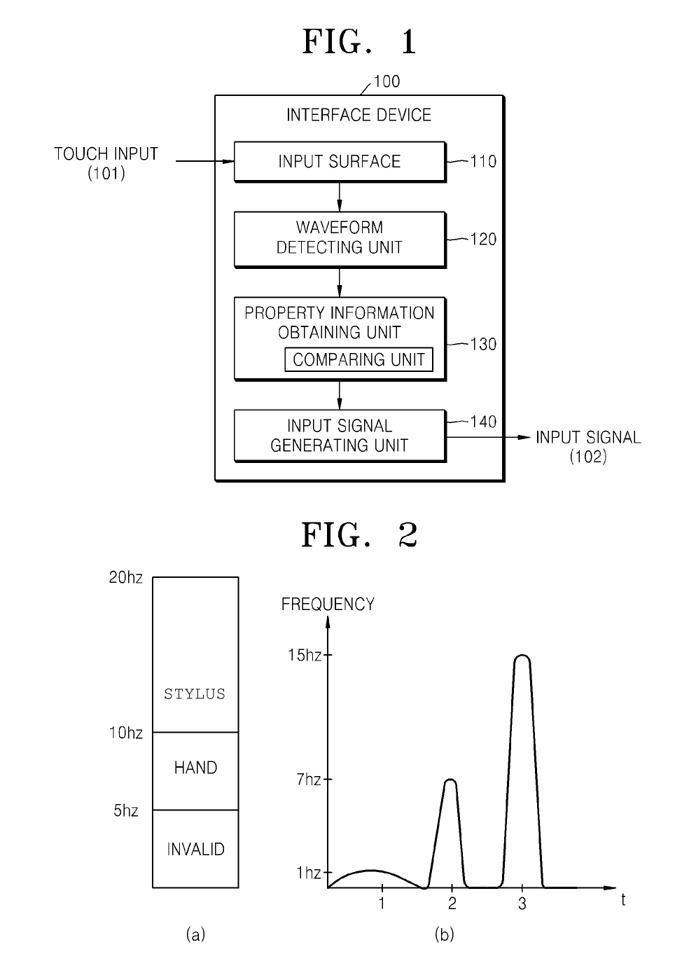

An example where the property information obtaining unit 130 obtains property information regarding input members by comparing detected waveforms with reference waveforms will be described with reference to FIG. 2.

The property information obtaining unit 130 may compare a reference waveform with a detected waveform in consideration of various factors such as a shape, an envelope, an amplitude, a frequency, etc. of a waveform. In FIG. 2, for convenience of description, only a comparison between an average frequency of a reference waveform and an average frequency of a detected waveform will be performed.

A diagram (a) of FIG. 2 illustrates a range of an average frequency of a reference waveform generated the input surface 110 is touched (by a hand or a stylus). Referring to FIG. 2A, if an average frequency of a detected waveform is in the range of 10 to 20 hz, it is determined that an input member is a stylus, if an average frequency of a detected waveform is in the range of 5 to 10 hz, it is determined that an input member is a finger, and if an average frequency of a detected waveform is less than 5 hz, it is determined that a touch input is invalid. Graph (b) of FIG. 2 shows waveforms detected by the waveform detecting unit 120.

At a point of ‘1’ second, since a waveform having an average frequency of 1 hz was detected, it is determined that a corresponding touch input was invalid.

At a point of ‘2’ second, since a waveform having an average frequency of 7 hz was detected, it is determined that a touch was performed using a finger.

At a point of ‘3’ second, since a waveform having an average frequency of 15 hz was detected, it is determined that a touch was performed using a stylus.

A user may add a reference waveform of a new input member. For example, the user selects an item for registering of a new input member, and then touches the input surface 110 by using the new input member. The interface device 100 stores a generated waveform as a reference waveform of the new input member.

The property information obtaining unit 130 may obtain property information regarding an input member by comparing a plurality of waveforms that are simultaneously or sequentially detected.

When similar input members, such as a thumb and an index finger, touch the input surface 110, property information may not be obtained by simply comparing detected waveforms with reference waveforms. The property information obtaining unit 130 may obtain exact property information regarding an input member by comparing detected waveforms with each other.

A case where the property information obtaining unit 130 obtains property information by using information obtained by using the input surface 110 and a detected waveform together will now be described.

When the input surface 110 includes a capacitive overlay touchpad, the property information obtaining unit 130 may obtain property information regarding an input member by using an electrical signal received from the input surface 110. If an input member that is a conductor touches the capacitive overlay touchpad, an electrical signal is generated. On the other hand, if an input member that is a nonconductor touches the capacitive overlay touchpad, no electrical signal is generated. Accordingly, when no electrical signal is generated, if the waveform detecting unit 120 has detected a waveform, it can be determined that a nonconductor was used as an input member.

When the input surface 110 includes a resistive touchpad, the property information obtaining unit 130 may obtain property information regarding an input member by using pressure information received from the input surface 110. For example, a vibration generated when a stylus touches the input surface 110 while a palm is placed on a bottom of the input surface 110 may be different from a vibration generated when the stylus touches the input surface 110 while the palm is not in contact with the bottom of the input surface 110. Accordingly, since one input member can generate different vibrations, it may be impossible to determine whether a stylus touches the input surface 110 or a finger touches the input surface 110 by using only a waveform of a vibration. However, it may be determined which input member is used to touch the input surface 110 by using pressure information together with a sensed waveform.

Also, the property information obtaining unit 130 may obtain property information by using a size or shape of a contact surface formed when an input member touches the input surface 110. The input signal generating unit 140 generates an input signal corresponding to combination of a property of an input member and a gesture generated by the input member.

When a plurality of input members contact the input surface 110, the input signal generating unit 140 selects which input member is a valid member for generating a touch input based on property information. When a user attempts to input a touch using a stylus, a user's finger may inadvertently make contact with the input surface 110. The input signal generating unit 140 may determine that only a stylus is a valid input member, and thus may generate an input signal based on only a gesture generated by a stylus.

When it is determined that each of a plurality of input members are valid, the input signal generating unit 140 may generate an input signal corresponding to a combination of gestures generated by each input member based on property information of the input members.

A function corresponding to a gesture generated by one input member may be independent from a gesture generated by another input member or may be related to a gesture that is continuously or simultaneously generated by another input member. In the former case, a function performed according to a gesture generated by an input member is performed again if the same gesture is generated by the same input member. However, in the latter case, a function performed according to a gesture generated by a first input member may be different from a function performed according to the same gesture generated by the first input member if there is a gesture generated by a second input member before or after the gesture generated by the first input member.

For example, it is assumed that a user touches the input surface 110 by using a stylus. In the former case, the same function (for example, selecting an item) is performed in both a case where a user touches the input surface 110 by using a stylus with his or her hand touching the input surface 110 and a case where the user touches the input surface 110 by using the stylus with his or her hand detached from the input surface 110. On the other hand, in the latter case, different functions (for example, selecting an item and moving the item) may be respectively performed in a case where a user touches the input surface 110 by using a stylus with his or her hand touching the input surface 110 and a case where the user touches the input surface 110 by using the stylus with his or her hand detached from the input surface 110. In particular, in the latter case, only gestures generated by input members contacting the input surface 110 at the same time or within a threshold time may be considered.

The interface device 100 may further include a control unit (not shown), and the control unit may control functions to be performed corresponding to generated input signals.

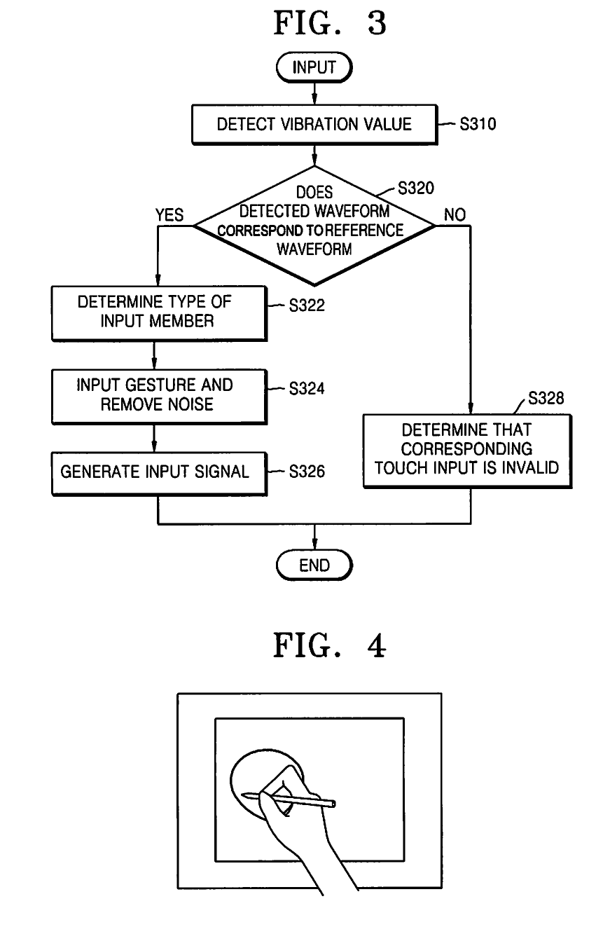

FIG. 3 is a flowchart illustrating an interfacing method, according to an embodiment of the present invention.

In FIG. 3, it is assumed that a function corresponding to a gesture generated by each of input members is independent from gestures generated by all other input members. Thus, a function corresponding to a gesture generated by an input member is not affected by a gesture generated by another input member.

In step s310, a waveform is detected from a sound or a vibration generated when an input member touches an input surface for receiving a touch input. In step s320, a reference waveform corresponding to the detected waveform is detected by comparing the detected waveform with the reference waveform. If a reference waveform corresponding to the detected waveform does not exist, step s328 is performed to determine that the touch is invalid. Alternatively, if a reference waveform corresponding to the detected waveform does not exist, the detected waveform may be registered as a new waveform or a prompt window may ask the user to confirm such registration.

In step s332, property information of the input member is obtained according to the result of the comparing step s320. As described above, the property information of the input member may include a type or shape of the input member. In step s324, a gesture generated by the input member is input and noise is removed. In step s326, an input signal corresponding to the property information of the input member and the input gesture is generated.

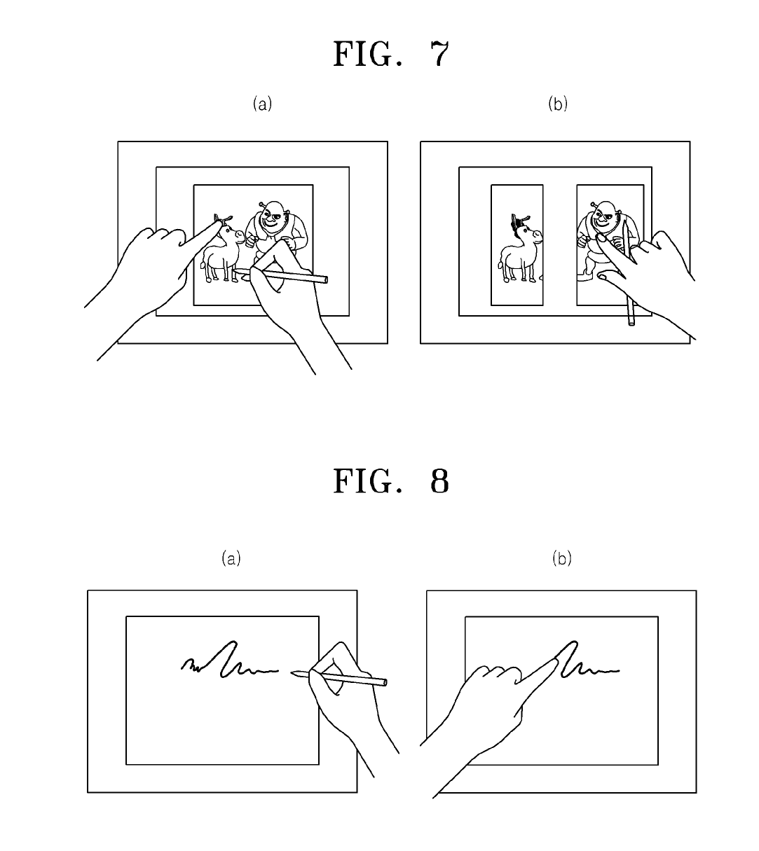

FIGS. 4 through 12 are diagrams illustrating a method of performing a touch input using the interface device 100 of FIG. 1. In particular, FIGS. 4 through 6 illustrates a case where a function corresponding to a gesture generated by each of input members is affected by a gesture generated by another input member, and FIGS. 7 through 11 illustrates a case where a function corresponding to a gesture generated by each of input members is not affected by a gesture generated by another input member.

In FIG. 4, a user touches the input surface 110 by using a stylus while the user's palm is touching the input surface 110 according to an embodiment of the present invention.

The waveform detecting unit 120 detects a first waveform generated when the user's palm touches the input surface 110 and a second waveform generated when the stylus touches the input surface 110. The property information obtaining unit 130 checks input members based on each waveform. The input signal generating unit 140 selects valid input members based on property information regarding the input members. In FIG. 4, only the stylus is determined as a valid input member, and the user's palm is determined as an invalid input member. Accordingly, the input signal generating unit 140 may generate an input signal corresponding to movement of the stylus.

A conventional interface device may not distinguish a material of an input member. Thus, when the user unintentionally touches the input surface 110, the wrong input signal is generated. However, in the interface device 100 according to the present invention, an exact input signal may be generated by obtaining property information of the input member and then distinguishing valid input members from invalid input members.

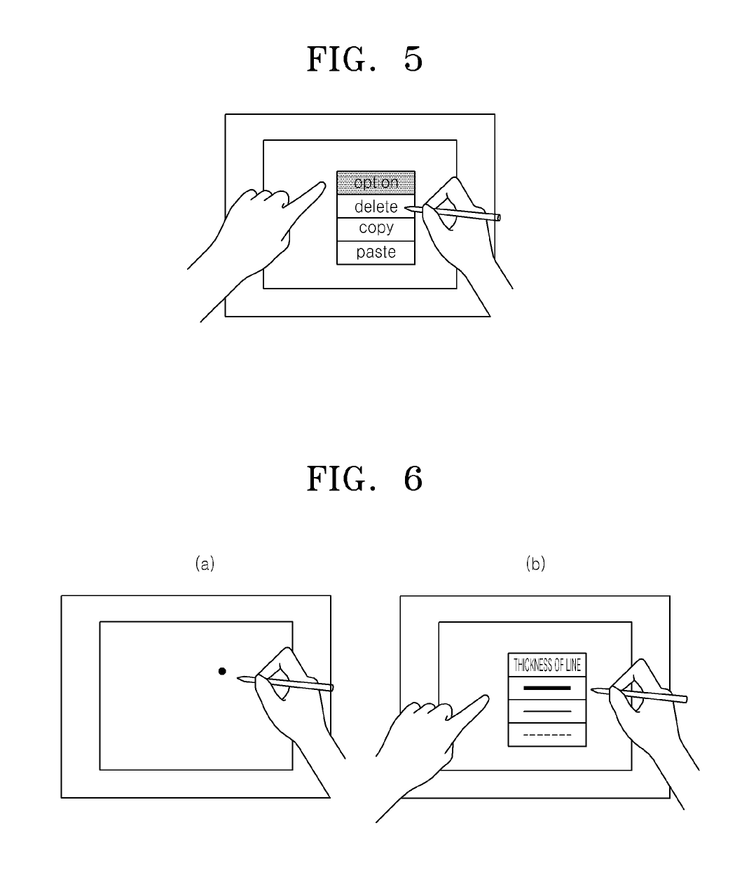

FIG. 5 is a diagram illustrating the interface device 100 on which a finger and a stylus are used as input members, according to an embodiment of the present invention.

When the input surface 110 is touched only by the stylus, tapping, long-pressing, dragging, operations, and the like performed in a general interface device may be performed. On the other hand, if the input surface 110 is touched by the stylus while the finger is touching the input surface 110, a pop-up is generated.

Thus, the interface device 100 may provide various functions that may not be provided by a conventional interface device by combining property information of two or more input members and gestures generated by the input members.

FIG. 6 is a diagram illustrating the interface device 100 on which a finger and a stylus are used as input members, according to another embodiment of the present invention.

Referring to part (a) of FIG. 6, when a user touches the input surface 110 by using the stylus, a dot is marked. Referring to part (b) of FIG. 6, if the user touches the input surface 110 by using the stylus while his or her finger is touching the input surface, a pop-up for selecting thicknesses of lines is output.

FIG. 7 is a diagram illustrating the interface device 100 on which a finger and a stylus are used as input members, according to another embodiment of the present invention.

Referring to part (a) of FIG. 7, if a user moves the stylus while his or her finger is touching an object, the object is divided along a moving path of the stylus. Referring to part (b) of FIG. 7, the user may move the object by dragging the divided object by using his or her finger.

FIG. 8 is a diagram illustrating the interface device 100 on which a finger and a stylus are used as input members, according to another embodiment of the present invention.

Referring to part (a) of FIG. 8, if a user moves the stylus on the input surface 110, a picture is drawn according to the movement of the stylus. Referring to part (b) of FIG. 8, if the user moves his or her finger on the input surface 110, the picture is erased according to the movement of the finger.

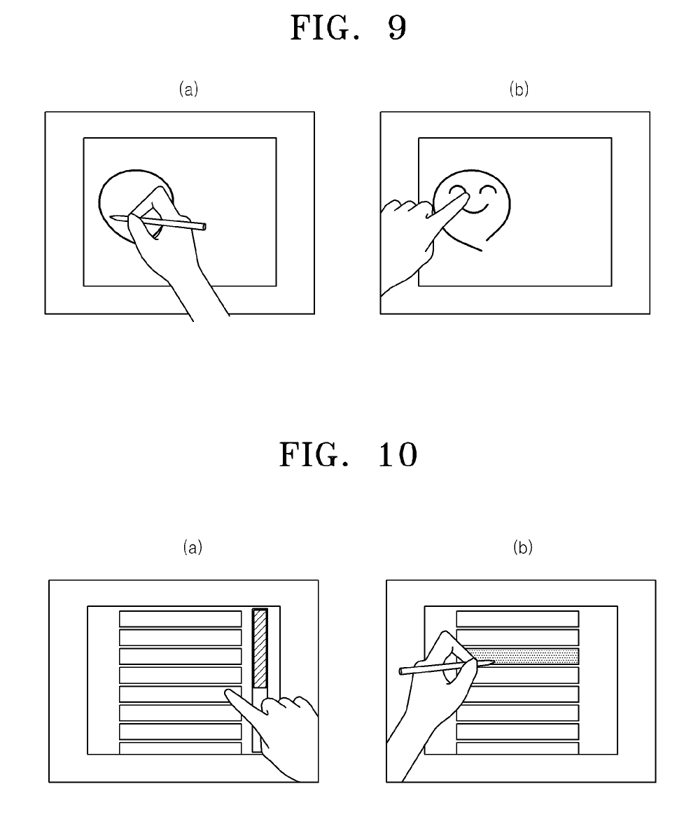

FIG. 9 is a diagram illustrating the interface device 100 on which a finger and a stylus are used as input members, according to another embodiment of the present invention.

Referring to part (a) of FIG. 9, if a user moves the stylus on the input surface 110, a picture is drawn according to the movement of the stylus. Referring to part (b) of FIG. 9, if the user moves his or her finger on the input surface 110, an object is moved according to the movement of the finger.

FIG. 10 is a diagram illustrating the interface device 100 on which a finger and a stylus are used as input members, according to another embodiment of the present invention.

Referring to part (a) of FIG. 10, if a user moves his or her finger on the input surface 110, a list is scrolled according to the movement of the finger. Referring to part (b) of FIG. 10, if the user moves the stylus on the input surface 110, one item of the list is controlled according to the movement of the stylus. For example, if the user taps with the stylus, one item is selected, and if the user drags with the stylus, a position of the corresponding item is moved.

FIG. 11 is a diagram illustrating the interface device 100 on which a finger and a stylus are used as input members, according to another embodiment of the present invention.

Referring to part (a) of FIG. 11, if a user moves his or her finger on the input surface 110, an entire screen is moving according to the movement of the finger. If a picture displayed on the screen is a map, the user moves his or her finger so as to display a hidden area on the screen. Referring to part (b) of FIG. 11, if the user moves the stylus on the input surface 110, a picture is drawn according to the movement of the stylus.

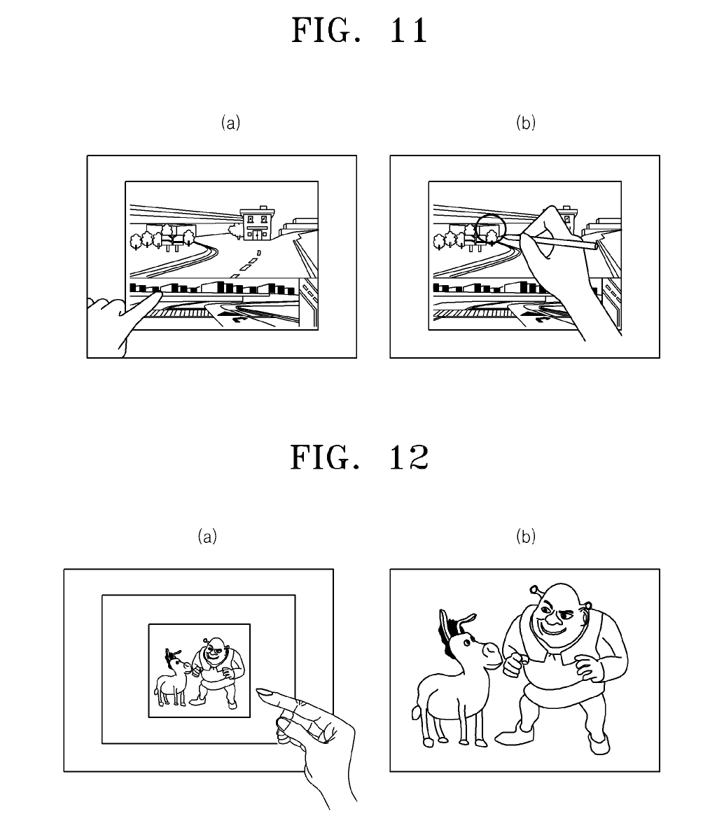

FIG. 12 is a diagram illustrating the interface device 100 on which a nail is used as an input member, according to another embodiment of the present invention.

In FIG. 12, the input surface 110 includes a capacitive overlay touchpad, and a user touches the input surface 110 by using his or her nail. When the user touches the input surface 110 by using his or her nail, although no electrical signal is generated from the capacitive overlay touchpad, the waveform detecting unit 120 may detect a waveform due to a vibration. In the current embodiment, the nail is just an example, and various other nonconductors may be used. If the property information obtaining unit 130 determines the nail as an input member according to no electrical signal and the waveform, the input signal generating unit 140 generates an input signal corresponding to a tapping operation corresponding to the nail.

Referring to part (a) of FIG. 12, if the user touches a screen by using his or her nail, a screen mode is changed from a full screen mode into a general screen mode as illustrated in part (b) of FIG. 12.

Since a conventional interface employing a capacitive overlay touchpad may use only a conductor as an input member, a function of the interface is limited. However, in an interface, according to the present invention, a function corresponding to gestures generated by a nonconductor may be set, and thus the interface may provide various functions.

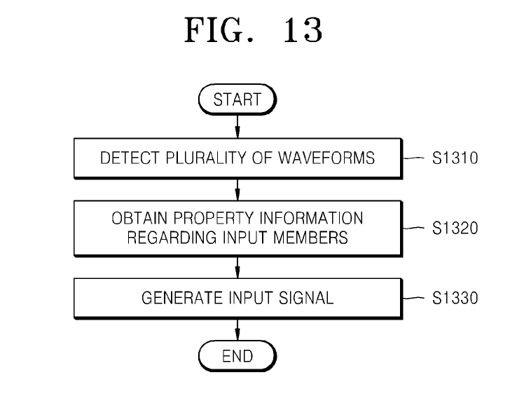

FIG. 13 is a flowchart illustrating an interfacing method, according to another embodiment of the present invention.

In step s1310, waveforms are detected from sounds or vibrations generated when a plurality of input members touch an input surface for receiving touch inputs. In step s1320, property information regarding the input members is obtained according to the detected waveforms. The property information may include information regarding types or shapes of the input members.

The property information of the input members may be obtained by comparing the detected waveforms with reference waveforms, comparing the detected waveforms with each other, and using electrical signals generated from a capacitive overlay touchpad or pressure signals generated from a resistive touchpad together with the detected waveforms.

In step s1330, an input signal corresponding to a combination of the property information of the input members and gestures generated by the input members is generated. The input signal may then be generated based on only the gesture generated by a valid input member.

A user may previously set a function according to a type of an input member and a gesture generated by the input member. Specifically, a function according to a type of an input member and a gesture generated by the input member may be set regardless of or in connection with a gesture of another input member.

The generated input signal is then processed, and the result may be displayed.

The present invention can also be embodied as computer readable codes on a computer readable recording medium. The computer readable recording medium is any data storage device that can store data which can be thereafter read by a computer system. Examples of the computer readable recording medium are Read-Only Memory (ROM), Random-Access Memory (RAM), CD-ROMs, magnetic tapes, floppy disks, optical data storage devices, and the like. The computer readable recording medium can also be distributed over network coupled computer systems so that the computer readable code is stored and executed in a distributed fashion.

While the present invention has been particularly shown and described with reference to embodiments thereof, it will be understood by one of ordinary skill in the art that various changes in form and details may be made therein without departing from the spirit and scope of the present invention as defined by the following claims. The embodiments should be considered in descriptive sense only and not for purposes of limitation. Therefore, the scope of the invention is defined not by the detailed description of the invention but by the appended claims and their equivalents, and all differences within the scope will be construed as being included in the present invention.

What is claimed is:

1. An interface method, the method comprising:
detecting waveforms generated due to contact between a plurality of input members and an input surface for receiving touch inputs;
obtaining property information regarding each of the input members based on the detected waveforms; and
generating an input signal corresponding to a combination of the property information of the input members and gestures generated by the input members.

2. The interface method of claim 1, wherein obtaining property information comprises:
comparing one or more reference waveforms stored in a database with the detected waveforms.

3. The interface method of claim 1, wherein obtaining property information comprises:
comparing the detected waveforms with each other.

4. The interface method of claim 1, wherein generating input signal comprises:
selecting a valid input member from the plurality of input members according to the property information; and
generating the input signal based on the gesture generated by the valid input member.

5. The interface method of claim 1, wherein the input surface comprises:
a capacitive overlay touchpad, and obtaining of the property information includes obtaining the property information according to an electrical signal generated due to contact between the input members and the touchpad and the detected waveforms.

6. The interface method of claim 1, wherein the input surface comprises:
a resistive touchpad, and the obtaining of the property information comprises:
obtaining the property information according to a pressure change generated due to contact between the input members and the touchpad and the detected waveforms.

7. The interface method of claim 1, wherein obtaining property information comprises:
obtaining the property information according to the detected waveforms and at least one of a size and a shape of a contact surface between the input members and the input surface.

8. The interface method of claim 1, wherein detecting waveforms comprises:
detecting waveforms generated due to contact between the plurality of input members and the input surface within a predetermined time.

9. The interface method of claim 1, wherein the property information comprises:
at least one of information regarding types of the input members and information regarding shapes of the input members.

10. The interface method of claim 1, wherein detecting waveforms comprises:
detecting at least one waveform of a sound and a vibration generated due to contact between the plurality of input members and the input surface.

11. The interface method of claim 1, wherein the gestures comprise:
at least one of tapping, pressing, long-pressing and dragging operations.

12. An interface device, the device comprising:
an input surface for receiving touch inputs of a plurality of input members;
a waveform detecting unit for detecting waveforms generated due to contact between the plurality of input members and the input surface for receiving touch inputs;
a property information obtaining unit for obtaining property information regarding each input member according to the detected waveforms; and
an input signal generating unit for generating an input signal corresponding to a combination of the property information of the input members and gestures generated by the input members.

13. The interface device of claim 12, wherein the property information obtaining unit comprises:
a comparing unit for comparing one or more reference waveforms stored in a database with the detected waveforms.

14. The interface device of claim 12, wherein the property information obtaining unit comprises:
a comparing unit for comparing the detected waveforms with each other.

15. The interface device of claim 12, wherein the input signal generating unit selects a valid input member from among the plurality of input members according to the property information, and generates the input signal according to the gesture generated by the valid input member.

16. The interface device of claim 12, wherein the input surface comprises:
a capacitive overlay touchpad, and the property information obtaining unit obtains the property information according to an electrical signal generated due to contact between the input members and the touchpad and the detected waveforms.

17. The interface device of claim 12, wherein the input surface comprises:
a resistive touchpad, and the property information obtaining unit obtains the property information according to an electrical signal generated due to contact between the input members and the touchpad and the detected waveforms.

18. The interface device of claim 12, wherein the property information obtaining unit obtains the property information according to the detected waveforms and at least one of a size and a shape of a contact surface between the input members and the input surface.

19. The interface device of claim 12, wherein the waveform detecting unit detects waveforms generated due to contact between the plurality of input members and the input surface within a predetermined time.

20. The interface device of claim 12, wherein the property information comprises at least one of information regarding types of the input members and information regarding shapes of the input members.

21. The interface device of claim 12, wherein the waveform detecting unit detects at least one waveform of a sound and a vibration generated due to contact between the plurality of input members and the input surface.

22. The interface device of claim 12, wherein the gestures comprise at least one selected from the group consisting of tapping, pressing, long-pressing and dragging.

23. A computer readable recording medium having embodied thereon a computer program for executing a method, the method comprising:
detecting waveforms generated due to contact between a plurality of input members and an input surface for receiving touch inputs;
obtaining property information regarding each of the input members based on the detected waveforms; and
generating an input signal corresponding to a combination of the property information of the input members and gestures generated by the input members.
